(19) United States
(12) Patent Application Publication
(10) Pub. No.: US 2023/0121610 A1
(43) Pub. Date: Apr. 20, 2023

(54) METHOD OF PROVIDING TRAVEL PLAN CREATION MANAGEMENT SERVICE AND SYSTEM FOR SAME

(71) Applicant: Won Young YUN, Seoul (KR)

(72) Inventor: Won Young YUN, Seoul (KR)

(21) Appl. No.: 17/909,700

(22) PCT Filed: Feb. 15, 2021
(86) PCT No.: PCT/KR2021/001857

§ 371 Date: Sep. 6, 2022

(30) Foreign Application Priority Data
Mar. 6, 2020 (KR) 10-2020-0028687

(51) Int. Cl. G06Q 50/14; G06Q 10/1093; G01C 21/34

(52) U.S. Cl. CPC G06Q 50/14; G06Q 10/1093; G01C 21/343

(57) ABSTRACT

Provided is a method of providing a travel plan creation and management service. The method includes: displaying first point information, second point information, and a stopover button on a user terminal; and displaying a stopover candidate list including stopovers when the stopover button is input, wherein the stopover candidate list includes a first stopover group satisfying a first condition that transportation connecting the first point and the stopover to each other exists, and a second stopover group, which satisfies a second condition that transportation connecting the stopover and the second point to each other exists in the first stopover group is separately displayed.

### BACKGROUND OF THE INVENTION

### Field of the Invention

The present disclosure relates to a method of providing a travel plan creation management service and system for same.

### Description of the Related Art

Existing travel products are configured with most travel schedules determined in advance and it is difficult to find a travel product reflecting individual tastes or circumstances of consumers.

Recently, as the internet is increasingly popularized and users increase, individual consumers can easily access information for travel such as tourist attractions, accommodation information, traffic information, etc., and more people attempt to make their own travel plan including their favorite areas. However, detailed tourist schedules, routes, useful information, etc., which travel agencies have accumulated while selling a great number of travel products and guiding travelers for a long period of time, are difficult to be reflected when consumers individually make a travel plan through internet search, and it is troublesome for consumers to individually contact all products for travel such as accommodation, an airline ticket, etc., make a reservation, and pay for them.

### SUMMARY OF THE INVENTION

An aspect of the present disclosure can provide a method of providing a travel plan creation and management service, the method being able to efficiently create and manage a user-fit travel plan.

An aspect of the present disclosure can provide a system for providing a travel plan creation and management service, the system being able to efficiently create and manage a user-fit travel plan.

A method of providing a travel plan creation and management service according to an embodiment of the present disclosure may include: displaying first point information, second point information, and a stopover button on a user terminal; and displaying a stopover candidate list including stopovers when the stopover button is input, wherein the stopover candidate list may include a first stopover group satisfying a first condition that transportation connecting the first point and the stopover to each other exists, and a second stopover group, which satisfies a second condition that transportation connecting the stopover and the second point to each other exists in the first stopover group may be separately displayed.

In this case, in the second stopover group, the sum of a first estimated time that is taken to move from the first point to the stopover, a second estimated time that is taken for sightseeing at the stopover, and a third estimated time that is taken to move from the stopover to the second point may be within a period range between a schedule end time point at the first point to a schedule start time point at the second point.

Further, the stopover candidate list may separately display a third stopover group further satisfying a third condition that an available accommodation facility exists in the second stopover group.

Further, when any one of stopovers not included in the second stopover group is selected from the first stopover group, a travel schedule sequentially passing through the first point, the stopover, the first point, and the second point may be made.

Further, the first point information, the second point information, and the stopover candidate list may be displayed in a map included in a GUI provided to the user terminal.

A system for providing a travel plan creation and management service according to an embodiment of the present disclosure includes a server connected to a user terminal through a wired/wireless communication network and provides a service for creating and managing a travel plan, wherein the server includes: a database including user information, point information, and traffic information; a GUI control module controlling a GUI provided to a user terminal; and a stopover extraction module extracting and providing a stopover to the GUI control module, the GUI control module provides schedule information image including first point information, second point information, and a stopover button and provides a stopover candidate list including stopovers to the schedule information image when the stopover button is input, the stopover extraction module extracts stopovers included in the stopover candidates, and the stopovers include a first stopover group satisfying a first condition that transportation connecting the first point and the stopover to each other exists and a second stopover group satisfying a second condition that transportation connecting the stopover and the second point to each other exists in the first stopover group.

According to an embodiment of the present disclosure, there is provided an effect that a user can simply and efficiently make or change a desired travel schedule and can efficiently manage schedules and travel routes during traveling.

In particular, when a new travel spot is added to predetermined travel destinations, travel destinations that can be added are recommended in consideration of the existing travel destinations, so it is possible to easily and simply make a well-scheduled travel plan.

### BRIEF DESCRIPTION OF THE DRAWINGS

FIG. 1 is a block diagram schematically exemplifying a system for providing a travel plan creation and management service according to an embodiment of the present disclosure;

FIG. 2 is a diagram for describing a predetermined GUI that is displayed in the system for providing a travel plan creation and management service according to an embodiment of the present disclosure;

FIG. 3 is a diagram for describing a predetermined GUI that is displayed in the system for providing a travel plan creation and management service according to an embodiment of the present disclosure;

FIG. 4 is a flowchart schematically exemplifying a method of providing a travel plan creation and management service according to an embodiment of the present disclosure;

FIG. 5 is a flowchart for describing the method of providing a travel plan creation and management service according to an embodiment of the present disclosure;

FIG. 6 is a flowchart for describing the method of providing a travel plan creation and management service according to an embodiment of the present disclosure; and

FIG. 7 is a flowchart for describing the method of providing a travel plan creation and management service according to an embodiment of the present disclosure.

### DETAILED DESCRIPTION OF THE INVENTION

The advantages and features of the present disclosure, and methods of achieving them will be clear by referring to the exemplary embodiments that will be describe hereafter in detail with reference to the accompanying drawings. However, the present disclosure is not limited to the disclosed embodiments and may be implemented in other various ways. The embodiments may be provided to make the present disclosure clear and completely inform those skilled in the art of the scope of the present disclosure. Like reference numerals indicate like components throughout the specification.

The terms used herein are provided to describe embodiments without limiting the present disclosure. In the specification, a singular form includes a plural form unless specifically stated in the sentences. The terms “comprise” and/or “comprising” used herein do not exclude that another component, step, operation, and/or element exist or are added in the stated component, step, operation, and/or element.

Hereafter, the configuration and operation effects of the present disclosure are described in more detail with reference to the accompanying drawings.

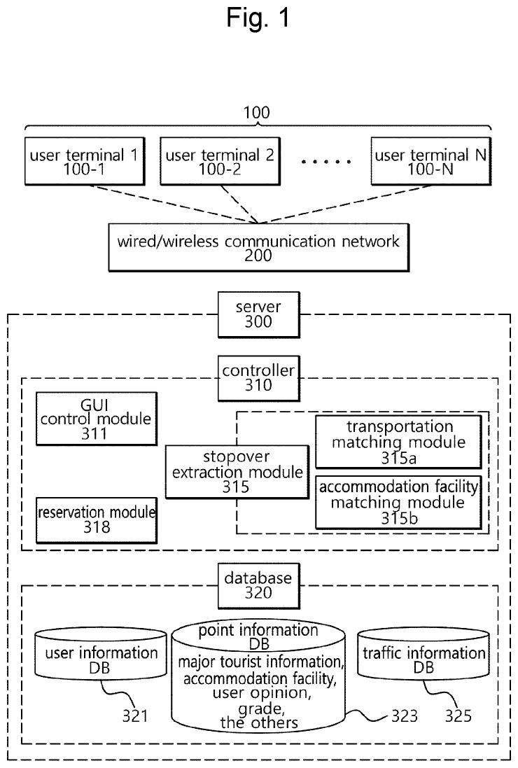

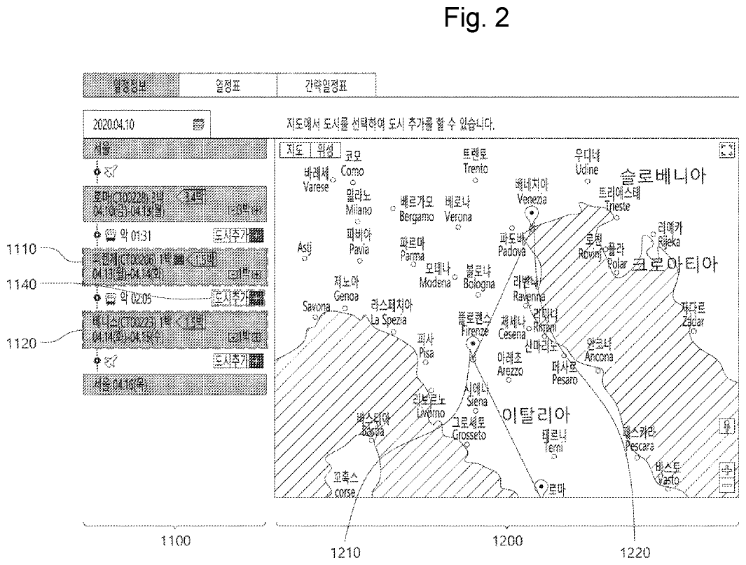

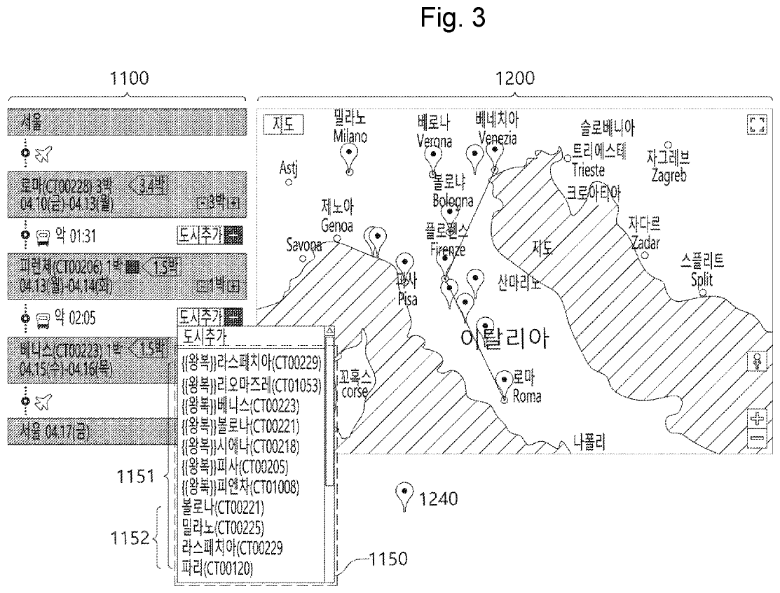

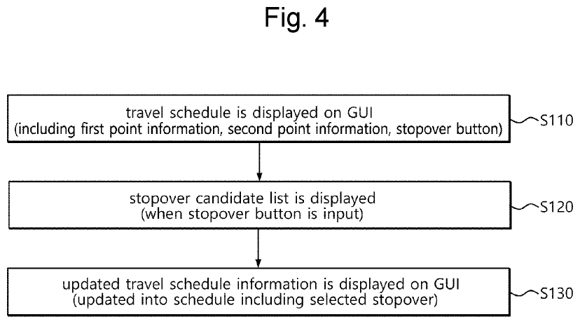

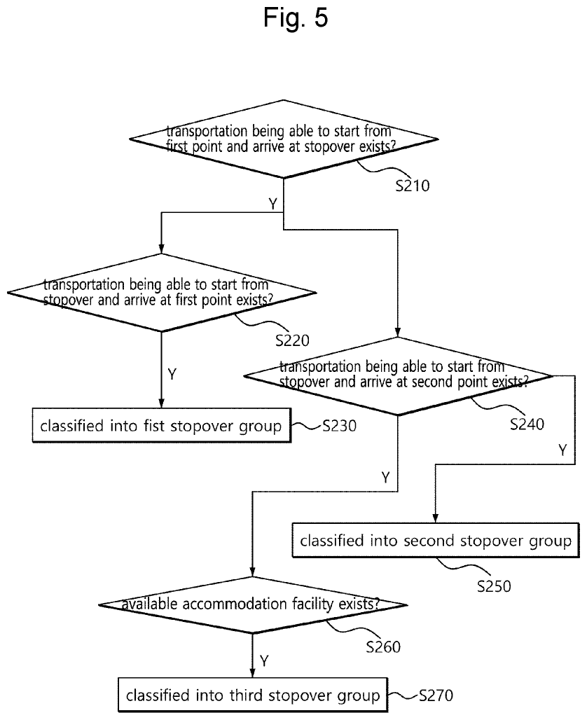

FIG. 1 is a block diagram schematically exemplifying a system 1000 for providing a travel plan creation and management service according to an embodiment of the present disclosure, FIGS. 2 and 3 are diagrams for describing a predetermined GUI that is displayed in the system 1000 for providing a travel plan creation and management service according to an embodiment of the present disclosure, FIG. 4 is a flowchart schematically exemplifying a method of providing a travel plan creation and management service according to an embodiment of the present disclosure, and FIGS. 5 to 7 are flowcharts for describing the method of providing a travel plan creation and management service according to an embodiment of the present disclosure.

A server 300 of a system 1000 for providing a travel plan creation and management service according to an embodiment of the present disclosure includes a database 320 and a controller 310. The server 300 may be connected with a user terminal 100 through a wired/wireless communication network 200 and the user terminal 100 may include a smartphone, a tablet PC, a computer, etc. In an embodiment, the server 300 may be implemented in a local server type that is directly constructed and managed by a company that provides a service to which the present disclosure is applied. In another embodiment, the server 300 may be implemented in a cloud server type that is provided by a global large enterprise, etc.

In an embodiment, user information, point information, and traffic information can be stored in the database 320. To this end, the database 320 may include a user information DB 321, a point information DB 323, and a traffic information DB 325.

In an embodiment, the sex, age, personality, and taste of a user, the kinds of fellow travelers (family, lover, friend, etc.), etc. can be stored in the user information DB 321. Further, a travel plan that is created by a user can be stored in the user information DB 321. In an embodiment, a predetermined travel plan can be created by mixing point information and traffic information that are selected by a user.

In an embodiment, point information such as main tourist information, which includes cities, famous restaurants, or famous tourist spots that a user is visiting, accommodation facilities, user opinions, and grades can be stored in the point information DB 323. Meanwhile, information of points that require a reservation of the point information can be linked with a specific reservation module 318.

In an embodiment, information such as the schedules of transportation such as airlines, trains, buses, ships, etc. can be stored in the traffic information DB 325. In this case, for airlines, data can be collected in cooperation with an airline schedule inquiry system API and stored in the traffic information DB 325. Further, for trains, data can be stored in the traffic information DB 325 in cooperation with an API of each railroad administration or operating company. Further, it is possible to connect with the API of an operating company for buses, ferries, or the like if it is possible, and if not so, driving information posted on the homepage of each operating company, offline information, or the like can be collected and stored in the traffic information DB 325.

In an embodiment, the controller 310 may further include a GUI control module 311 and a stopover extraction module 315, and may further include a reservation module 318. In this case, the GUI control module 311 may mean a function unit that performs a function of creating, changing, and managing a GUI that is provided by the user terminal 100. Further, the extraction module 315 can perform a function of extracting and providing a stopover between a first point and a second point to the GUI control module 311.

An example in which the GUI control module 311 of the system 1000 for providing a travel plan creation and management service according to an embodiment of the present disclosure displays a GUI on the user terminal 100 is exemplified in FIGS. 2 and 3. In an embodiment, a schedule information image including first point information 1110, second point information 1120, and a stopover button 1140 may be displayed on the GUI. In this case, when the stopover button 1140 is input by mouse click, a touch, keyboard input, etc., a stopover candidate list 1150 including stopovers may be displayed in the GUI. Further, a user can select and input a stopover that the user prefers from the stopover candidate list, and accordingly, a travel plan including a first point, a selected stopover, and a second point can be created. In an embodiment, means of transportation related to the stopover may also be selected in the process of selecting the stopover. For example, when an airline and a train both exist as transportation connecting a first point and a stopover, a stopover candidate list may be displayed in a way of displaying a stopover (airline) and a stopover (train). In another embodiment, when a predetermined stopover is selected, a list of transportation candidates that move from a first point to the stopover may be displayed. Further, a user can select predetermined transportation from the list of transportation candidates. In an embodiment, a function of making it possible to reserve or pay for selected transportation may be implemented through the reservation module 318.

In an embodiment, the first point information 1110, the second point information 1120, and the stopover button 1140 may be displayed in a first region 1100, and items of point information may be displayed on the basis of texts in the first region 1100. In an embodiment, a second region 1200 for displaying a map may be further included in the GUI. A first point icon 1210, a second point icon 1220, a stopover candidate icon 1240, etc. may be displayed at locations, respectively, in the map of the second region 1200. In an embodiment, at least one selected from the first region 1100 and the second region 1200 may be displayed on the user terminal 100, depending on setting by a user. That is, on the user terminal 100, only the first region 1100 may be displayed, only the second region 1200 may be displayed, or both the first region 1100 and the second region 1200 may be displayed.

In an embodiment, the stopover extraction module 315 can extract stopovers included in stopover candidates from the point information DB 323. In this case, the stopovers included in stopover candidates may include a first stopover group satisfying a first condition. In this case, the first condition may include that transportation that starts from a first point and reaches a stopover exists. Stopovers satisfying the first condition can be defined as a first stopover group. Meanwhile, in a narrow meaning, stopovers where transportation that starts from a first point and reaches a stopover and transportation that starts the stopover and arrives at the first point both exist may be defined as a first stopover group.

In an embodiment, the stopovers included in stopover candidates may include a second stopover group satisfying a second condition. In this case, the second condition may include that transportation that starts from a stopover and reaches a second point exists. Stopovers satisfying the second condition can be defined as a second stopover group. Meanwhile, in a narrow meaning, the second stopover group may be made include only the stopovers included in the first stopover group. That is, a second stopover group may be defined by only stopovers where transportation between a first point and a stopover exists and transportation that starts from the stopover and arrives at the second point exists.

In an embodiment, when a stopover candidate list is displayed, a first stopover group and a second stopover group may be displayed to be discriminated. That is, it is possible to make two groups be discriminated by applying different colors or different headers. Referring to FIG. 3, the entire of a stopover group candidate list 1150 may mean a first stopover group 1151. Further, some of the first stopover group 1151 may be displayed as a second stopover group 1152. Further, stopovers that do not correspond to the second stopover group 1152 may exist in the first stopover group 1151, and in an embodiment, a header “round-trip” may be designated to these stopovers. In an embodiment, when the first stopover group 1151 does not correspond to the second stopover group 1152, a travel schedule sequentially passing through a first point, a stopover, the first point, and a second point is made.

In an embodiment, a third stopover group that satisfies a third condition in the second stopover group may be separately displayed. In this case, the third condition may include that an available accommodation facility exists. In an embodiment, when a third stopover group is selected, a GUI making it possible to reserve accommodation can be output.

In an embodiment, the stopover extraction module 315 may include a transportation matching module 315a to extract transportation that satisfies the first condition or the second condition described above. Further, the stopover extraction module 315 may include an accommodation facility matching module 315b to extract accommodation facilities that satisfy the third condition.

In an embodiment, whether there is transportation between points may be derived in cooperation with the point information DB 323 and the traffic information DB 325.

In an embodiment, when a plurality of means of transportation exists, it is possible to determine priority in consideration of a travel time, a transportation fee, accessibility, and past sell data. In this case, when accessibility is determined and when an airport is far but a train or a bus is close, an additional point may be given to the train or the bus. Further, it is possible to adjust sequence such that stopovers where high-priority transportation exists are exposed first. Further, when a specific stopover is selected, transportation for moving to the selected stopover can be displayed, and in this case too, means of transportations are arranged in priority sequence so that a user can make a choice.

In an embodiment, only cases in which there is transportation having a travel time within a predetermined range may be included in the first stopover group. In this case, the predetermined time range may be set by a user. In an embodiment, the stopover extraction module 315 can automatically calculate a predetermined time range. To this end, the stopover extraction module 315 can derive a first estimated time that is taken to move from a first point to a stopover. Further, the stopover extraction module 315 can derive a second estimated time that is taken for sightseeing at a stopover. Further, the stopover extraction module 315 can derive a third estimated time that is taken to move from the stopover to a second point. Further, the stopover extraction module 315 can determine a stopover candidate by determining whether the sum of the first estimated time, the second estimated time, and the third estimated time is within a period range between a schedule end time point at the first point to a schedule start time point at the second point. In an embodiment, when deriving the first estimated time and the third estimated time, it is preferable to consider not only an average travel time of transportation, but a time that is taken to move to a station where it is possible to use the transportation, the waiting time at the station, etc.

In an embodiment, the reservation module318 can perform a function of making it possible to inquire a present reservation situation of points requiring a reservation, for example, accommodation facilities and tourist spots requiring an entrance ticket of points, and to progress reservation, payment, etc. Further, the reservation module 318 can perform a function of making it possible to inquire the schedules of transportation for moving, etc., and to progress payment, etc.

Referring to FIG. 4, a method of providing a travel plan creation and management service according to an embodiment of the present disclosure may include a step of displaying travel schedule information in a GUI (S110), a step of displaying a stopover candidate list (S120), and displaying updated travel schedule information in a GUI (S130).

In an embodiment, travel schedule information may include first point information, second point information, and stopover button.

In an embodiment the step of displaying a stopover candidate list (S120) can be performed by displaying a stopover candidate list when the stopover button is input. In this case, the stopover candidates, as described above, can be extracted by the stopover extraction module 315. In an embodiment, when a first point and a second point are selected in advance by a user, the stopover extraction module 315 can derive the first stopover group to the third stopover group described above using data stored in the database 320.

Referring to FIG. 5, in an embodiment, whether transportation that can start from a first point and arrive at a predetermined stopover exists at the stopover is determined with the first point and a second point determined (S210), and when transportation exists, the stopover is classified into a first stopover group. In this case, whether transportation that can start from the stopover and arrive at the first point exists (S220), and when transportation exists, the stopover may be classified into the first stopover group (S230). It is possible to derive the first stopover group by repeatedly performing this process on stopovers.

In an embodiment, whether transportation that can arrive at the second point exists at a predetermined stopover included in the first stopover group is determined (S240), and when transportation exists, the stopover is classified into a second stopover group (S250). It is possible to derive the second stopover group by repeatedly performing this process on stopovers included in the first stopover group.

In an embodiment, whether and available accommodation facility exists at a predetermined stopover included in the second stopover group is determined (S260), and when an available accommodation facility exists, the stopover is classified into a third stopover group (S270). It is possible to derive the third stopover group by repeatedly performing this process on stopovers included in the second stopover group.

In an embodiment when a user selects a predetermined stopover in a stopover candidate list, travel schedule information can be updated and displayed in a GUI such that the selected stopover is added (S130). In this case, if necessary, a GUI for reserving transportation or an accommodation place related to the stopover is displayed, so reservation or payment can be progressed.

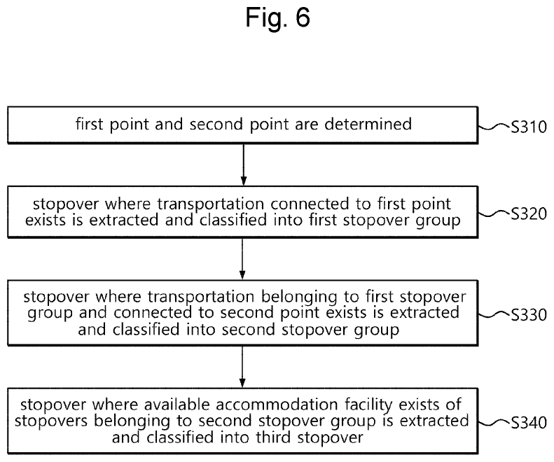

Referring to FIG. 6, in an embodiment, when a first point and a second point are determined (S310), it is possible to extract and classify stopovers, where transportation connected to the first point exists, into a first stopover group (S320). nNext, it is possible to extract and classify stopovers, which belong to the first stopover group and where transportation connected to the second point, into a second stopover group (S330). Next, it is possible to extract and classify stopovers, which belong to the second stopover group and where an available accommodation facility exists, into a third stopover group (S340). In an embodiment, a process of extracting stopovers of which the distances from the first point and the second point are within a predetermined range may be performed before step S320 is performed. Accordingly, it is possible to attenuate the problem that a travel distance or a travel time on a travel route unnecessarily greatly increases even if a stopover is added.

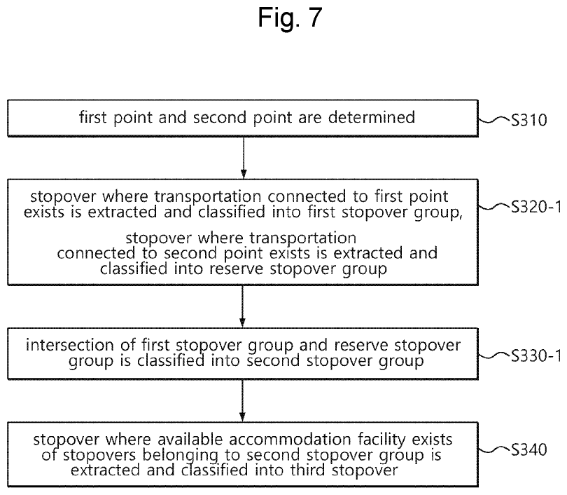

Referring to FIG. 7, in an embodiment, the method may include the following steps before step S310 and step S340 instead of step S320 and step S330. First, it is possible to extract a stopover where transportation connected with the first point exists and a stopover where transportation connected with the second point exists into a first stopover group and a reserve stopover group (S320-1). Next, it is possible to an intersection of the first stopover group and the reserve stopover group as a second stopover group (S330-1).

In an embodiment, the controller 310 can extract a recommendation package using information of a user stored in the user information DB 321. For example, the controller 310 analyzes the sex, age, personality, and taste of a user, and the kinds of fellow travelers and analyzes statistics of other previous cases similar to the analyzed result, thereby being able to create a recommendation package. For example, when a user is a 31 year-old woman, travels with a friend, and prefers exercise, etc., it is possible to recommend a package including the first point and the second point in consideration of the travel courses, satisfaction, etc. of other users who were similar in age and sex, traveled with a friend, and included a lot of exercises. The user who checked this recommendation package can make a schematic travel plan by selecting the first point and the second point in consideration of the proposed recommendation matters. Further, since it is possible to use a result in which whether there is transportation, whether there is an accommodation facility, etc. were reflected in advance in the process of making a plan for a stopover between a first point and a second point, it is possible to easily make a travel plan with a minimum effort.

In an embodiment, in the process of creating a recommendation package, preference, required time, etc. for users, travel themes, travel seasons, and travel areas may be generally reflected in the process of creating a recommendation package.

Since an embodiment of the present disclosure can help make a travel plan, it can be used in an industry that provides individualized services to consumers in online and offline. Further, the present disclosure can be used in various industries related to travel such as a travel business, a tour business, a restaurant business, and an exhibition hall business, etc.

What is claimed is:

1. A method of providing a travel plan creation and management service, the method comprising:
displaying first point information, second point information, and a stopover button on a user terminal by means of a server; and
displaying a stopover candidate list including stopovers when the stopover button is input through the user terminal,
wherein the stopover candidate list includes a first stopover group satisfying a first condition that transportation connecting the first point and the stopover to each other exists, and
the server displays a second stopover group, which satisfies a second condition that transportation connecting the stopover and the second point to each other exists in the first stopover group, to be discriminated from the first stopover group.

2. The method of claim 1, wherein, in the second stopover group, the sum of a first estimated time that is taken to move from the first point to the stopover, a second estimated time that is taken for sightseeing at the stopover, and a third estimated time that is taken to move from the stopover to the second point is within a period range between a schedule end time point at the first point to a schedule start time point at the second point.

3. The method of claim 2, wherein the stopover candidate list separately displays a third stopover group further satisfying a third condition that an available accommodation facility exists in the second stopover group.

4. The method of claim 1, wherein when any one of stopovers not included in the second stopover group is selected from the first stopover group, a travel schedule sequentially passing through the first point, the stopover, the first point, and the second point is made.

5. The method of claim 1, wherein the first point information, the second point information, and the stopover candidate list are displayed in a map included in a GUI provided to the user terminal.

6. A system for providing a travel plan creation and management service, the system comprising a server connected to a user terminal through a wired/wireless communication network, and providing a service for creating and managing a travel plan,
wherein the server includes:
a database including user information, point information, and traffic information;
a GUI control module controlling a GUI provided to a user terminal; and
a stopover extraction module extracting and providing a stopover to the GUI control module,
the GUI control module provides schedule information image including first point information, second point information, and a stopover button and provides a stopover candidate list including stopovers to the schedule information image when the stopover button is input,
the stopover extraction module extracts stopovers included in the stopover candidates, and
the stopovers include a first stopover group satisfying a first condition that transportation connecting the first point and the stopover to each other exists and a second stopover group satisfying a second condition that transportation connecting the stopover and the second point to each other exists in the first stopover group.

7. A method of providing a travel plan creation and management service, the method comprising:
displaying first point information, second point information, and a stopover button on a user terminal by means of a server; and
displaying a stopover candidate list including stopovers when the stopover button is input through the user terminal,
wherein the stopover candidate list includes a first stopover group satisfying a first condition that transportation connecting the first point and the stopover to each other exists,
the server displays a second stopover group, which satisfies a second condition that transportation connecting the stopover and the second point to each other exists in the first stopover group, to be visually discriminated from the first stopover group,
when a stopover not belonging to the second stopover group is selected through the user terminal, the server makes a travel schedule sequentially passing through the first point, the selected stopover, the first point, and the second point,
in the second stopover group, the sum of a first estimated time that is taken to move from the first point to the stopover, a second estimated time that is taken for sightseeing at the stopover, and a third estimated time that is taken to move from the stopover to the second point is within a period range between a schedule end time point at the first point to a schedule start time point at the second point,
the server derives the first estimated time by summing up a travel time between a first station, where first transportation connecting the first point and the stopover can be used, and the first point, a waiting time at the first station, and an average travel time of the first transportation, and
the server derives the third estimated time by summing up a travel time between a second station, where second transportation connecting the stopover and the second point can be used, and the second point, a waiting time at the second station, and an average travel time of the second transportation.
